(19) United States
(12) Patent Application Publication
(10) Pub. No.: US 2005/0223277 A1
(43) Pub. Date: Oct. 6, 2005

(54) Online storage system

(75) Inventor: Clinton L. Ballard, Suquamish, WA (US)

Correspondence Address: KODA LAW OFFICE, No 141, 8070 E Mill Plain Blvd, Vancouver, WA, 98664-2002, US

(73) Assignee: eAcceleration Corporation, Poulsbo, WA (US)

(21) Appl. No.: 10/808,033

(22) Filed: Mar. 23, 2004

(51) Int. Cl. G06F 11/00

(52) U.S. Cl. 714/15

(57) ABSTRACT

Files from a client are backed up over the internet onto a back-up storage area. The client gathers identifying information for each file, including file size and file checksum. A client server estimates whether the information matches that present in a database including identifying information from multiple clients. When the information for a given file is present, the matched information is stored in the back-up storage area. When the information is not present, the given file is received from the client computer. The given file and the associated identifying information then are stored in the back-up storage area. The backed-up files are accessible in online storage, and may be archived. The client accesses the backed-up files over the internet in a restore operation, or as a virtual hard disk, a virtual CD image or a virtual DVD image. The backed-up files are accessible offline on a CD or DVD.

### BACKGROUND OF THE INVENTION

The present invention is directed to methods and apparatus for online storage, and more particularly to a system for backing up files over the internet.

It is extremely expensive and time consuming to regenerate data stored on a computer that is lost due to a system failure, user error, or another reason. To avoid regenerating the information from scratch, it is common practice to back-up computer files. For example, a complete system back-up stores the operating system, application programs and user data on a system or media which is separate from the user's computer. Incremental back-ups store files that have changed since an earlier back-up or the last complete back-up.

There are different degrees of automation and features among back-up software. The programs which require the most user involvement require the user to start the program, select the files, identify the destination, and load in the destination media. Some applications automate the process by performing a back-up at a preset time. In a local area network environment, a network administrator may be the person that controls the back-up operations or that determines the automation of the back-up.

One of the challenges with backing up data is to get the user to do the back-up periodically or at all. The more time between back-ups the more information that is potentially lost after a failure event. Accordingly it is desirable to have a convenient, easy to use, back-up operation which involves little of the end user's time and attention.

### SUMMARY OF INVENTION

The online storage system allows files from client computers to be uploaded over the internet to a client server computer. The upload is part of a back-up operation or a publish operation. The upload operations are initiated at a client computer. For each file to be uploaded, the client computer gathers identifying information, including file size and file checksum data. The identifying information does not include the file contents. The gathered identifying information is sent over the internet to the client server computer. The client server computer creates an upload operation storage area for the operation. The client server computer determines whether the identifying information for each file to be backed up matches identifying information present in a database on the client server computer. The database being checked includes identifying information from multiple client computers among the plurality of client computers. When the identifying information for a given file is present, the matched identifying information for the given file is stored in the upload operation storage area. When the identifying information for a given file is not present in the database, the given file, including the file contents, is received from the client computer. The given file and the associated identifying information then are stored in the upload operation storage area.

### BRIEF DESCRIPTION OF THE DRAWINGS

FIG. 1 is a block diagram of an online storage system network environment;

FIG. 2 is block diagram of a computer system within the environment of FIG. 1;

FIG. 3 is a block diagram of one embodiment of a user interface for the online storage system;

FIG. 4 is a data diagram of one embodiment of a packet routed from a client computer to a client server computer for requesting an operation;

FIG. 5 is a block diagram of one embodiment of a processor and memory for a client server;

FIG. 6 is a data diagram of one embodiment of an operation log for the online storage system;

FIG. 7 is a data diagram of one embodiment of a file log for the online storage system;

FIG. 8 is a data diagram of one embodiment of a central database for the online storage system;

FIG. 9 is a data diagram of one embodiment of a reference storage area for the online storage system;

FIG. 10 is a flow chart of one embodiment of a command interpreter running at each client computer;

FIG. 11 is a flow chart of one embodiment of client server operation processing running at the client server;

FIG. 12 is a flow chart of one embodiment of processing performed at the client computer in response to a request from the client server;

FIG. 13 is a continued flow chart of the command interpreter of FIG. 10 for additional commands;

FIG. 14 is a continued flow chart of the client sever operation processing of FIG. 11 for additional operations;

FIG. 15 is a block diagram of another embodiment of the processor and memory for the client server; and

FIG. 16 is a flow chart of another embodiment of client server processing running at the client server.

### DESCRIPTION OF SPECIFIC EMBODIMENTS

Online Storage System Environment

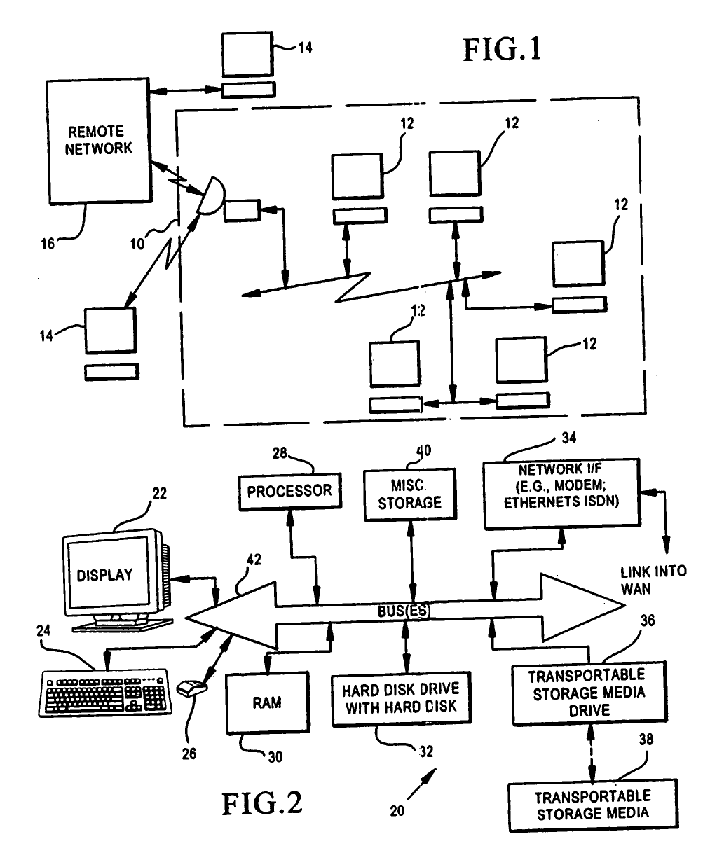

FIG. 1 shows an online storage system network environment embodied as a wide area network 10. The network 10 is formed by a plurality of network server computers 12 which are interlinked. Each network server computer 12 stores documents accessible to other network server computers 12 and to client computers 14 and networks 16 which link into the wide area network 10. The configuration of the wide area network 10 may change over time as client computers 14 and one or more networks 16 connect and disconnect from the network 10. For example, when a client computer 14 and a network 16 are connected with the network servers computers 12, the wide area network includes such client computer 14 and network 16. As used herein the term computer includes any device or machine capable of accepting data, applying prescribed processes to the data, and supplying results of the processes.

The wide area network 10 stores information that is accessible to the network server computers 12, remote networks 16 and client computers 14. The term document as used herein, includes files (as per the Windows operating system usage), documents (as per the MacOS operating system usage), pages (as per the web phraseology usage), and other records, entries or terminology used to describe a unit of a database, a unit of a file system or a unit of another data collection type, whether or not such units are related or relational.

The network server computers 12 are formed by mainframe computers minicomputers, and/or microcomputers having one or more processors each. The server computers 12 are linked together by wired and/or wireless transfer media, such as conductive wire, fiber optic cable, and/or microwave transmission media, satellite transmission media or other conductive, optic or electromagnetic wave transmission media. The client computers 14 access a network server computer 12 by a similar wired or a wireless transfer medium. For example, a client computer 14 may link into the wide area network 10 using a modem and the standard telephone communication network. Alternative carrier systems such as cable and satellite communication systems also may be used to link into the wide area network 10. Still other private or time-shared carrier systems may be used. In one embodiment the wide area network is a global information network, such as the internet. In another embodiment the wide area network is a private intranet using similar protocols as the internet, but with added security measures and restricted access controls. In still other embodiments the wide area network is a private, or semi-private network using proprietary communication protocols.

The client computer 14 is any end user computer, and may also be a mainframe computer, minicomputer or microcomputer having one or more microprocessors. The remote network 16 may be a local area network, a network added into the wide area network through an independent service provider (ISP) for the internet, or another group of computers interconnected by wired or wireless transfer media having a configuration which is either fixed or changing over time. Client computers 14 may link into and access the wide area network 10 independently or through a remote network 16.

Computer System

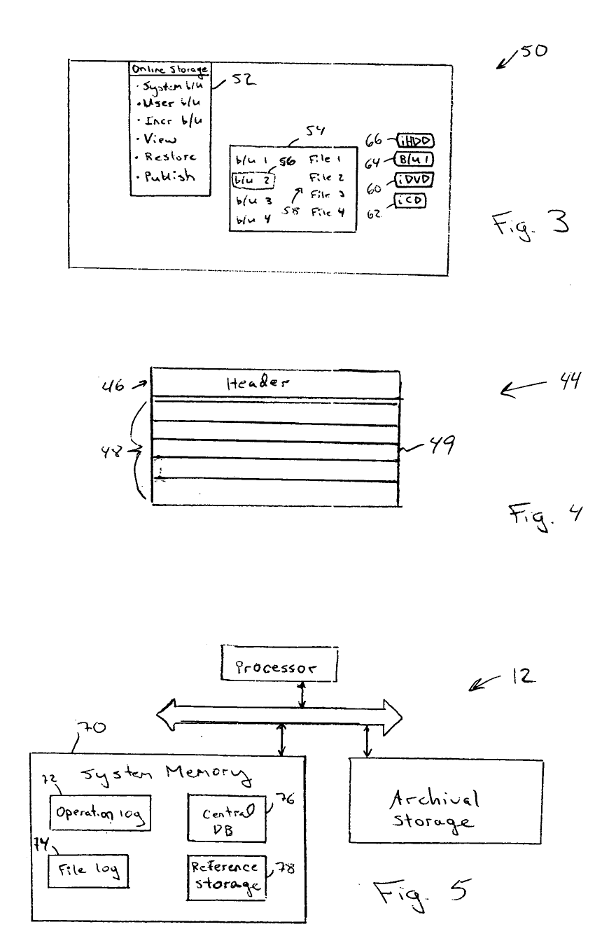

The functions of the present invention preferably are performed by programmed digital computers of the type which are well known in the art, an example of which is shown in FIG. 2. A computer system 20 has a display 22, a keyboard 24, a pointing/clicking device 26, a processor 28, random access memory (RAM) 30, a non-volatile storage device such as a hard disk drive 32, and a communication or network interface 34 (e.g., modem; ethernet adapter). In other embodiments the system 20 also includes a transportable storage media drive 36 which reads transportable storage media 38, and/or other miscellaneous storage devices 40, such as a floppy disk drive, CD-ROM drive, zip drive, bernoulli drive or other drive for a magnetic, optical or other storage media. The various components interface and exchange data and commands through one or more busses 42. The computer system 20 receives information by entry through the keyboard 24, pointing/clicking device 26, the network interface 34 or another input device or input port. The computer system 20 may be any of the types well known in the art, such as a mainframe computer, minicomputer, or microcomputer and may serve as a network server computer 12, remote network 16 computer or a client computer 14. The computer system 20 may even be configured as a workstation, personal computer, network server, or a reduced-feature network terminal device.

Client Computer User Interface (50)

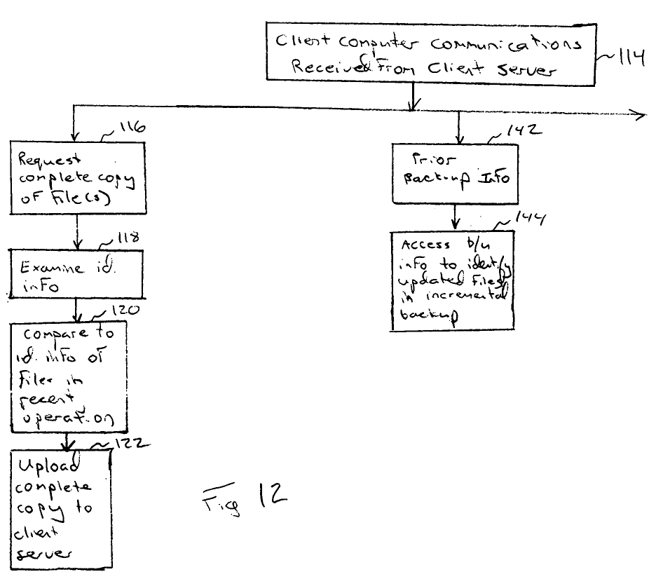

Referring to FIGS. 3 and 9, the user communicates with the online storage system through a set of commands. The commands are accessible by a menu 52, by clicking on an icon, or as part of an automated routine. An exemplary set of commands, includes: request full system back-up, request programmed template back-up, request incremental back-up, view list of back-ups accessible, view directory of a select back-up, restore from back-up, publish file set. In addition there are settings such as: length of time to maintain back-up before discarding, length of time to maintain back-up in system before archiving, archive for media delivery to client.

A full system back-up is an upload of identifying information for every file on the client computer, including system files. A programmed template back-up is an upload of identifying information for files selected by the user. An incremental back-up is references to a prior back-up, and is an upload of any changed files since the reference back-up. In some embodiments there also is a user data back-up command. User data determined heuristically. In one embodiment user data is all data within the My Documents directory on a Windows system.

A user can request to view a list of back-ups previously made to the client server. The client server downloads the list of back-up information for back-ups made by the requesting client computer. The downloaded information includes a back-up time stamp or another identification (such as a title) for each back-up. For example, a dialogue box 54 opens listing the back-ups for the client computer. The user can select to examine a specific back-up 56, including a directory of files 58. The user can select to restore one or more specific files or an entire back-up.

A user can also use the back-up features as a publishing vehicle. A user uploads file images to be streamed onto a portable storage media, such as a CD or DVD. The user also can request a number of copies of the data. As a result, user data, such as word processing documents, pictures, video, or audio compositions are published. A DVD of a video is published. A CD of a set of audio compositions is published. An e-book of a textual composition is published. A photo album of photos or other graphics is published. A multimedia composition involving more than one form of data also may be published. In some embodiments a publication also is available for access from an icon on the client computer. For example, an image file or set of files is associated with an icon on the client computer for an iDVD 60 or an iCD 62. An iDVD is a DVD image that is stored on the client server and is accessible to the client computer. An iCDR is a CD-ROM or CD-R/W image that is stored on the client server and is accessible to the client computers. By clicking on the icon, the image (e.g., audio-video, or audio, or multimedia) is played-back on the client computer by being downloaded from the client server.

There are various user-programmable settings, also. With regard to a back-up operation, the user can select the length of time to maintain a back-up before the data is discarded, the length of time to maintain back-up as accessible in system memory, whether to archive the back-up data as part of the back-up process. The user can select to have an archival copy made onto portable media for delivery to the client or for offline storage at the client server. For example, the portable media then is mailed or otherwise delivered to the client for safekeeping. For offline storage at the client server, the user can request that the archive be mounted or loaded into system memory for user access. For a publishing operation, the user can select, for example, the number of copies and the media form.

In some embodiments, an icon 64 is created at the client computer for a given back-up. By clicking on the icon, the back-up directory is opened. In some embodiments, clicking or double-clicking starts a restore of the back-up to the client computer. In some embodiments, a virtual drive icon 66 is displayed at the client computer. Clicking on the icon results in a directory of the client computer's online storage contents at the client server computer. For example, the directory can be set to list the back-ups, and list the files within each back-up. By opening a file, the file is restored to the client computer. By double-clicking on a back-up, the back-up is restored—or a window dialogue is opened for commanding a restore of the opened back-up.

Online Storage Embodiment

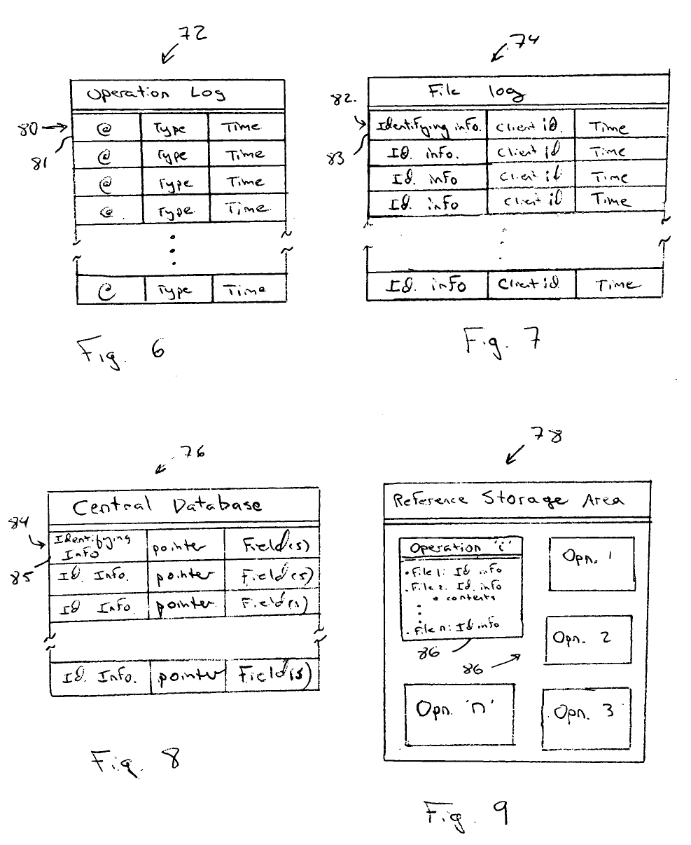

One embodiment of the data structures used for implementing the online storage system are shown in FIGS. 4-9. Referring to FIG. 4, the client computer 14 communicates with the server computer 12 using a packet 44. The packet 44 includes a header 46 and data 48. The data portion 48 includes records 49.

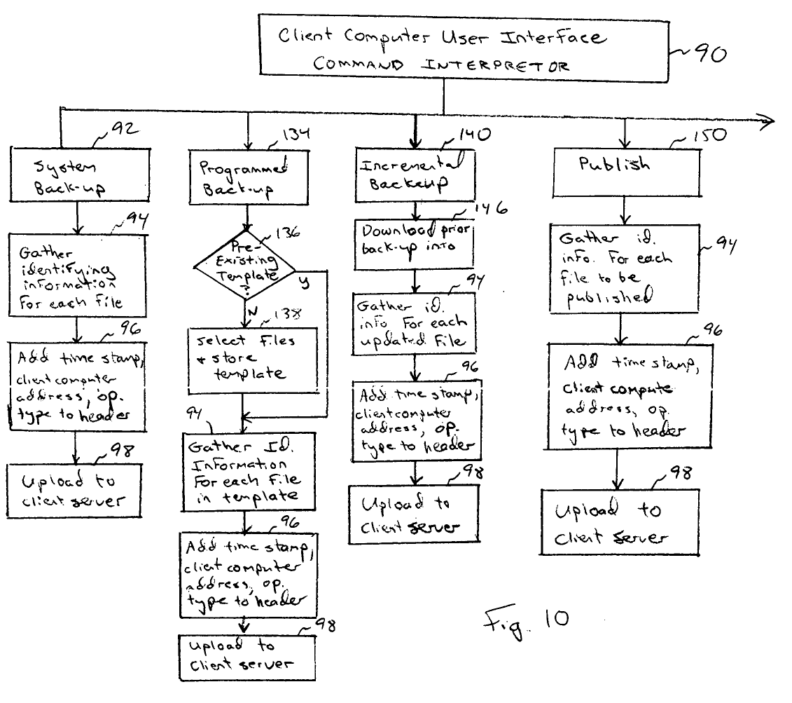

Referring to FIGS. 5-9, the client server 12 includes data structures stored in system memory 70 for implementing the online storage system. In one embodiment the data structures include an operation log 72, a file log 74, a central database 76, and a reference storage area 78. These data structures are maintained in system memory of the client server 12, and are used for handling operations requested by multiple client computers 14. The operation log 72, as shown in FIG. 6, includes an entry 80 for each operation (e.g., back-up, publish request) to the client server from any client computer. An entry 80 is formed by fields 81, including: a client computer address field (or other client identifier), an indication field of the type of operation (e.g., system back-up, programmed back-up, incremental back-up, publish), and a time stamp field. Different entries may correspond to different client computers.

Referring to FIG. 7, the file log 74 includes an entry 82 for each file to be backed up or uploaded from any back-up or publish operation of any client computer. An entry 82 includes fields 83 for identifying information for the file, such as file size and file checksum. In some embodiments other identifying information is stored also, such as filename, file type and/or file creation date. Each entry 82 also includes a field for a time stamp. In some embodiments each entry 82 also includes a field for a client computer identifier (e.g., client computer address). Different entries may correspond to different client computers.

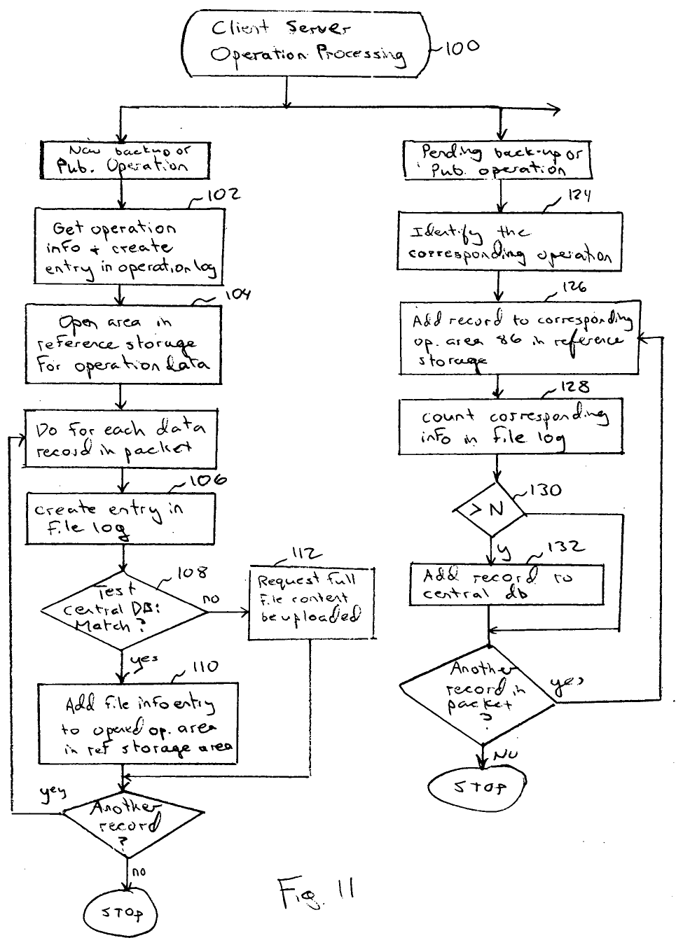

Referring to FIG. 8, the central database 76 includes records. Each record corresponds to a file which has been backed-up from one or more client computers. In a preferred embodiment each record corresponds to a file which has been backed-up from a plurality of client computers 14. Each record 84 includes fields 85 of file identifying information. The identifying information includes the file size and file checksum. As previously described file identifying information in some embodiments also includes filename, file type and/or file creation date. The identifying information does not include the file contents. In some embodiments, each record also includes a field 85 which is a pointer to the file contents for the file identified by the recorded information. The file contents are stored in compressed format or uncompressed format according to the embodiment.

In some embodiments, each record 84 also includes a field 85 for an aging marker, reference counter and/or client indicator. In one embodiment the aging marker is a timestamp. Each time a given record 84 is accessed, its timestamp is updated. Accordingly, the system is able to track the last time that a given record in the central database has been accessed. Records 84 not accessed within a prescribed or programmed time interval may be deleted. When a record 84 is deleted, the file contents indicated by the pointer field also are deleted. A reference counter counts the number of times that the corresponding file has been backed-up. By backed-up it is meant that the identifying information for the file is stored. As part of the back-up the file contents may or may not be uploaded also. Upload time is reduced by not having to upload the file contents when the file contents are already present in system memory.

Referring to FIG. 9, the reference storage area 78 includes a plurality of storage areas 86. Each area 86 is for a specific back-up or publish operation. Each area 86 includes data for each file in the back-up or publish. Specifically for each file, identifying information is stored. For some files the file contents also are stored. For a publish operation, area 86 includes the identifying information, and for some files further includes the file contents or a file image.

Back-Up Operations

Referring to FIG. 10, the client computer user interface 90 includes commands for different types of back-up operations, including a full system back-up, a programmed back-up and an incremental back-up. For each back-up operation, the client computer 14 generates a communication packet 46 uploaded to the client server 12. The packet includes a header 46 and data 48. The header 46 identifies the type of operation, the client computer address and a time stamp. The data 48 includes identifying information for each file to be backed up. The identifying information includes the file size and the file checksum. In some embodiments the identifying data also includes the filename, file type and/or creating date. The identifying data does not include the file contents.

For a system back-up 92, at step 94 the client computer processor gathers the identifying information for each file on the client computer being backed-up. (For a system back-up this is every file). At step 96, the client computer processor forms a packet header 46 including a time stamp, a client computer address and an operation type descriptor. At step 98, the packet 44, including the packet header and the packet data, is uploaded to the client server 12.

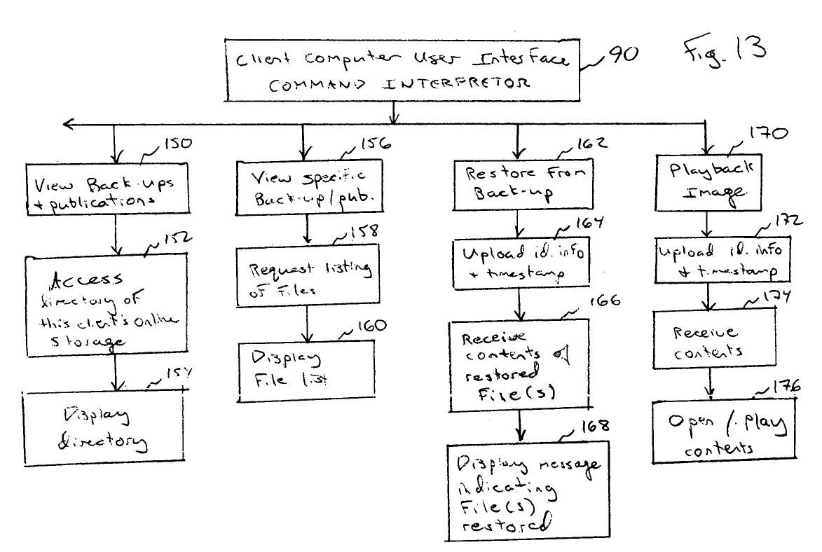

Referring to FIG. 11, the client server 12 receives the packet 44 for processing by routine 100. The packet corresponds to one of either a new operation or a pending operation. For a new operation, the header information is read at step 102. An entry 80 is made into the operation log 72, which includes the client computer address, the operation type and the time stamp. At step 104, an area 86 for storing the back-up data is created in the reference storage area 78. The data within the received packet then is processed.

For each file identified in the packet (e.g., for each record of identifying information), several steps are performed. At step 106, an entry 82 is created in the file log 74. The entry 82 includes the identifying information and the time stamp. In some embodiments the entry 82 also includes the client computer address or other information for identifying the client computer. At step 108, the central database is tested to determine whether there is a record in the central database 76 which matches the identifying information field of the current file information being processed for the current packet. If it matches then at step 110, the identifying information is included as an entry in the area 86 of the reference storage area 78 for the back-up operation being processed. In addition, for an embodiment in which the central database record includes a field for a time stamp, the timestamp is updated to track the most recent matching or other access of the specific central db record. If at step 108, the test determines that there is no matching record in the central database 76, then at step 112, a request is made to the client computer to upload the file contents of the corresponding file.

Referring to FIG. 12, the client computer process 114 processes operation-related communications received from the client server. For a request 116 by the client server 12 that the client computer 14 upload a full copy of a specific file, at step 118 the client computer parses the identifying information of the desired file from the received request. At step 120, the identifying information is compared to the identifying information gathered at step 94 (see FIG. 10). For a valid request (the identifying information in the request matches that of one file's identifying information in the previously transmitted packet), the complete file is uploaded to the client server at step 122. Preferably, such file is uploaded in a compressed format. Further, the identifying information for a file is the size and checksum for the file in uncompressed format. Although in some embodiment the identifying information is for the compressed file. To upload the file alone or with other files, a packet is formed including a header and data. The header includes the client computer address, the operation type (e.g., pending back-up operation) and a time stamp. The time stamp used is the same time stamp as for the corresponding original back-up packet previously uploaded.

Referring again to FIG. 11, the client server receives the packet and detects that the data is for a pending back-up operation. At step 124, the client server associates the packet with a specific, pending back-up operation by comparing the client address and the time stamp to those of pending back-up operations. At step 126, a record is added to the operation storage area 86 for the pending operation. The record includes the identifying information and the file contents. At step 128, the number of entries in file log 74 which have the same identifying information field are counted. For an embodiment in which the number of entries with the same identifying information is counted without regard to which client computer forced the entry into the log 74, the file log need not contain the client identification field in the entries 82. In an alternative embodiment, instead of counting the number of entries with the same identifying information, a count of the number of entries that have: (i) the same identifying information field and (ii) a unique client computer address are counted. Thus, the number of client computers which have backed-up the file with the same identifying information is counted.

At step 130, if the counted number exceeds a threshold value, N, then at step 132 a record 84 is added to the central database. The record includes the identifying information, a pointer to the file contents in the reference storage area and a reference value. In various embodiments the reference value differs. In one embodiment the reference value is a time stamp. Each time a back-up is performed where the identifying information is found in a record in the central database, the time stamp is updated. Accordingly, an indication of the last time a specific record has been tested is maintained.

Referring to FIGS. 10-12, for a programmed back-up operation 134, at step 136 a test is performed to determine whether there is a pre-existing template for the back-up. At step 138 if there is no pre-existing template, then the user selects the files to be backed up and stores such file list as a template. If the template already exists, then the template is opened. Steps 94, 96 and 98 then are performed as previously described for the system back-up operation to gather the identifying information for the files to be backed-up and to upload such identifying information to the client server 12. The packet header identifies the type of operation as a programmed template back-up. The client server computer 12 then processes the packet for the new operation implementing steps 102-110 of FIG. 11. In some instances the client server requests a full copy of files which do not have an entry in the central database 76. The client computer processes these requests at steps 116-122 (see FIG. 12) as previously described. Preferably, the full file is uploaded in a compressed format.

Referring again to FIGS. 10-12, for an incremental back-up operation 140, the client computer 14 generates a request for prior back-up information. At step 142 (see FIG. 12, the client server 12 processes this request. The client server 12 examines the prior back-up operation for the requesting client computer. For a full system back-up, the client server sends the time stamp for the full system back-up. For a partial back-up, the client server sends the time stamp of the back-up and in some embodiments also includes the identifying information for each record in the corresponding back-up operation area 86. At step 144, the client server 12 downloads the information to the client computer 14. Referring to FIG. 10, at step 146, the client computer 14 receives the information and identifies which files to include in the incremental back-up operation. Many conventional techniques for evaluating which files to include in the back-up exist and are implemented to select the files to be backed up. Steps 94, 96 and 98 then are performed as previously described for the system back-up operation. The identifying information for the files being backed-up is included in the uploaded packet 44. The packet header 46 identifies the type of operation as an incremental back-up. The client server computer 12 then processes the packet 44 for the new operation implementing steps 102-110 of FIG. 11. In some instances the client server requests a full copy of files which do not have an entry in the central database 76. The client computer processes these requests at steps 116-122 (see FIG. 12) as previously described. Preferably, such file is uploaded in a compressed format.

Client Server Clean-Up:

In one embodiment, the online storage system guarantees back-ups to be retained for a prescribed time period. During regular clean-up operations, the operation log, file log, central database and reference storage area are checked to see if any entries or records may be deleted. Operations in operation log 72 having a time stamp indicating a date more than a prescribed time interval earlier than the current date are deleted. Entries in the file log 74 having a time stamp indicating a date more than a prescribed time interval earlier than the current date are deleted. Any record in the central database 76 having a timestamp older than the prescribed period is deleted. Such record would not have been accessed at any time during the expired prescribed time period. When an operation entry is deleted from the operation log 72, the operation's data in the reference storage area 78 is reduced. Specifically, each record in corresponding area 86 of the reference storage area not having file contents is deleted. Each record with file contents remains, and gets deleted only when the corresponding record in the central database 76 is deleted.

To assure files are not inadvertently lost, in some embodiments the client server generates a message to a client computer when the last full system back-up was performed more than a set time ago. The set time, is less than the prescribed time for cleaning up the system so that the user has an opportunity to perform another full system back-up before the server's prescribed time period used for cleaning up the system expires.

Archival Storage

In some embodiments an archival copy is made of a back-up operation in addition to the online storage found in the system memory. In other embodiments an archival copy is made only if the user requests that an archived copy be made. An archival copy is a copy made to an offline media, such as a transportable media, (e.g., optical disc, CD, DVD, tape, or other media). The media then is stored and/or delivered to the user. The archived back-up includes the file contents of every file included in the back-up and not just the identifying information for each file. Referring to FIG. 11, when file information is added to the operation area 86 of the reference storage area 78, the file contents are added to an archival copy of the current back-up. The file contents are found by using the pointer in the central database for the corresponding file information. File contents also are added to the archival copy at step 126 when the entire file is uploaded and stored in area 86 of the reference storage area. Preferably, such file is stored in a compressed format. In some embodiments the archive instead includes the uncompressed file. For embodiments in which the archives are maintained as offline storage, the user is able to request that the archive be mounted or loaded into system memory. The user then is able to access the archived data within the online storage system. For example, the user can then view the back-ups or other operations on the mounted or loaded archive. The user can also download and restore from the mounted or loaded archive. In addition, the user can mount the archive locally in implementations where an archival copy is delivered to the user.

Publishing Operations:

In one embodiment a publishing operation 150 (see FIG. 10) is performed in the same manner as a programmed template back-up operation. The user selects the files to include in the publication. The client computer then performs the steps 94-98 and 116-122 (see FIG. 12) as for the system back-up operation. The header identifies the operation type as a publish operation. In some embodiments, the packet also includes a parameter for the number of copies to be published. The files are copied to the hard media as for an archival copy. The requested number of copies are delivered to the user. An online publication also may be done in which file images are uploaded to the client server and stored in an operation area 86 of the reference storage. The same steps are performed as previously described for the back-up operations. In addition, an icon is displayed at the client computer for the inline publication. The user can click on the icon to open a directory of the published files, or can double click on the icon to open the publication. By opening the publication the contents are streamed down to the client computer. In this manner, video works, audiovisual works, or other single or multimedia works are played back at the client computer by being streamed as a download from the client server 12. The publication is a virtual DVD image, a virtual CD image, a virtual directory of a specific back-up, or a virtual disk drive of files available to the user.

A user also can request that a prior back-up be made available as a virtual drive on the client computer. This operation is the same as a publication except that the client computer does not upload the file information. The file information is already on the client server. The client server 12 builds a directory of the files in the back-up. When the user requests to open the virtual drive, the client server downloads the directory to the client computer 14. When the user opens a file within the virtual directory, the client computer 14 sends a requests to have the corresponding file downloaded. The client server 12 downloads the file. In response the client computer 14 opens the file and activates the application for the file.

View, Restore and Playback Operations

A user can access a back-up or publication by a menu command, icon or through an automated routine, (see FIG. 3). In one embodiment an icon 66 for a virtual drive is created for the client computer desktop. By clicking on the icon the user requests to view a list of this particular client computer's back-ups and or publications accessible from the client server's online storage system. This also can be requested by a menu command.

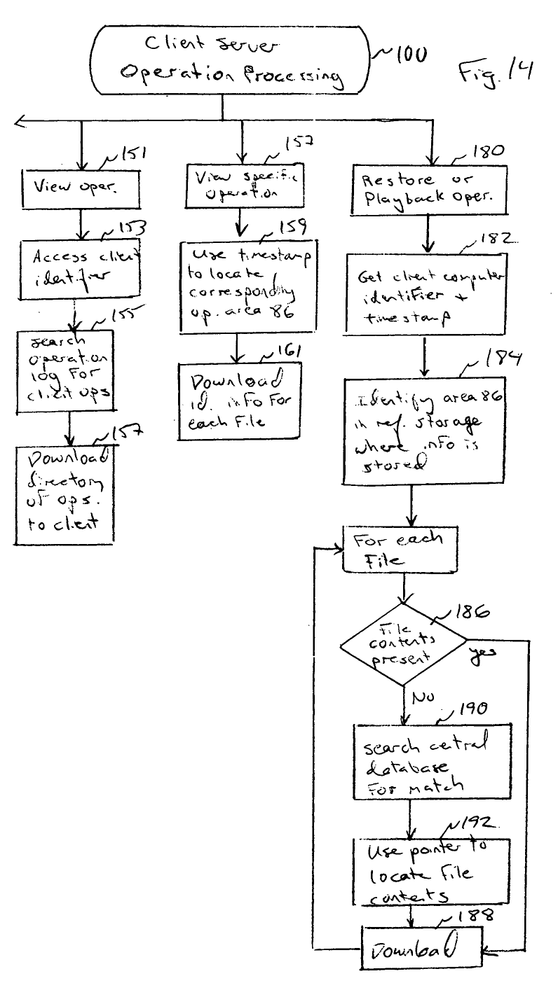

Referring to FIG. 13, a view command 150 includes sending a request for a directory of the client computer's online storage to the client server. The directory is compiled by the client server 12 and routed to the client computer 14 for current or later access. In some embodiments, a copy of this directory is retained locally in storage at the client computer 14, so that the view operation can be achieved at times without communications with the client server. In either embodiment, the client computer accesses the directory of information at step 152 and displays it to the user at step 154.

Referring to FIG. 14, for a view operation 151, the client server 12 receives a packet and at step 153 accesses the client computer identifier. At step 155, the operation log 72 is searched to find all back-up and/or publish operation entries 80 for the requesting client computer 14. At step 157, each found 80 entry is downloaded to the client computer 14. The downloaded information includes the fields 81 in the found entry 80 for the type of operation and the timestamp of the operation. The client computer displays the entries as a directory of operations. A title is either stored for a given entry or is formed automatically from the operation type and date.

Referring again to FIG. 13, a ‘view specific’ command 156 is performed by clicking on one of the operations in the directory displayed at step 154. The client computer sends a request at step 158 for the operation's directory (e.g., file list) to the client server computer 12. The specific operation is identified in the request by the time stamp field from the selected one of the found entries 80. Referring to FIG. 14 for a ‘view specific’ operation 157, the client server 12 at step 159 accesses the timestamp to search the reference storage area 78 for the corresponding operation storage 86. The identifying information for the operation then is downloaded to the client computer for display at step 161. Referring again to FIG. 13, at step 160 the listing is displayed. In an embodiment which includes the ‘view specific’ command, it is preferred that the identifying information stored in at least the reference storage area 78 include the filename.

A restore command 162 is performed by double-clicking on a specific back-up operation displayed at step 154 or by clicking on a file displayed at step 160. At step 164, the client computer uploads the identifying information for each file to be restored. The client computer also uploads the previously received operation timestamp to the client server 12. If the user selected a specific file, then the file is restored. If the user selected a specific back-up, then all files in the back-up are restored.

Referring to FIG. 14, for a restore operation 180, the client computer identifier and the timestamp are read from a received packet 44 at step 182. At step 184 the client server checks the corresponding operation area 86 to find the file(s) in the operation having the same timestamp. For each file having identifying information in the found area 86, the area is examined at step 186 to determine whether the file contents are included in the corresponding area 86. If present then the file contents are downloaded to the client computer 14 at step 188. Where the file contents are not present, at step 190 the central database 76 is searched for each remaining file to find the record 84 which matches the identifying information. The pointer field for the matching record 84 then is used at step 192 to access the file contents. The file contents are downloaded to the client computer 14 at step 188 and received at step 166. The client computer 14 then indicates at step 168 that the file(s) have been restored.

When the operation in the directory displayed at step 154 is a publication rather than a back-up, then double-clicking on the entry serves as a command 170 to playback the publication. In an embodiment where the ‘view select’ command is implemented, different files are displayed at step 160. The user can then click on a specific file of the publication to download and open/play. At step 172 the request is sent to the client server 12.

Referring to FIG. 14, for a playback operation 180, the client computer identifier and the timestamp are read from a received packet 44 at step 182. At step 184 the client server checks the corresponding operation area 86 to find the file(s) in the operation having the same timestamp. For each file having identifying information in the found area 86, the area is examined at step 186 to determine whether the file contents are included in the corresponding area 86. If present then the file contents are downloaded to the client computer 14 at step 188. Where the file contents are not present, at step 190 the central database 76 is searched for each remaining file to find the record 84 which matches the identifying information. The pointer field for the matching record 84 then is used at step 192 to access the file contents. The file contents are downloaded to the client computer 14 at step 188 and received at step 174. For text or graphics, a beginning file of the publication is opened at step 176. For a video, audio, audio-video or multimedia publication, the publication image is downloaded and played at step 176.

Alternative Embodiment

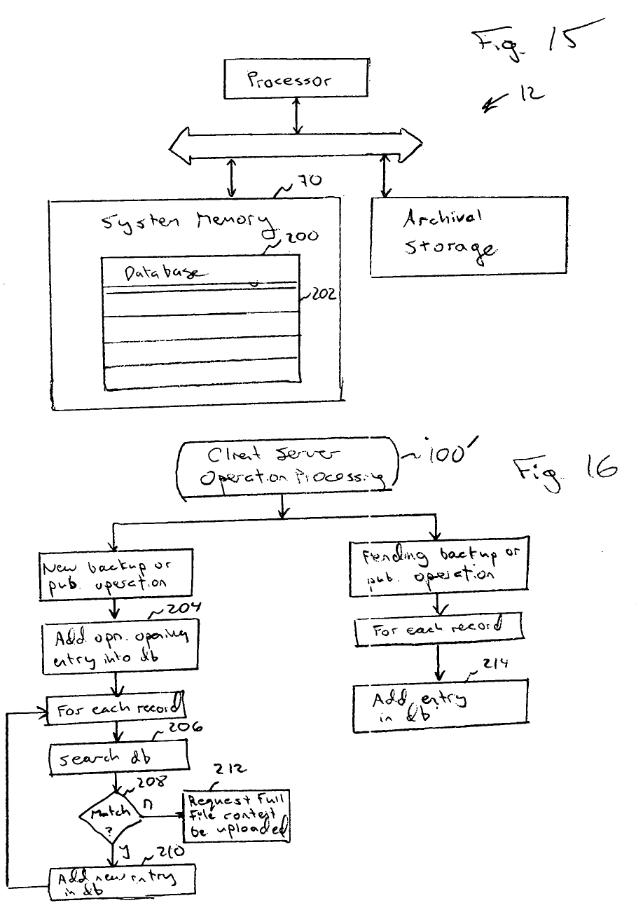

Referring to FIG. 15, in an alternative embodiment the online storage system is implemented as a file cache 200 within system memory 70. The file cache 200 includes entries 202. An entry 202 includes multiple fields. There is one or more fields for the identifying information of a file and a field for the time stamp. The identifying information does not include the file contents. Some entries also include a field for the file contents. Referring to FIG. 16, the client server 12 receives a packet for a client-specified operation as previously described with regard to FIG. 10. At step 204 an opening entry 202 is made for the operation in the database. The entry 202 includes a client computer identifier, such as a client computer address, and a timestamp. In some embodiments, the entry 202 also includes the type of operation (such as a back-up or publish operation). A series of steps then are performed for each record in the data portion of the packet. At step 206 the cache 200 is searched to see if there already is an entry for the identifying data listed in the current record. If at step 208, there is already an entry, then at step 210 a new entry is added to the database 200 which includes the identifying information and the time stamp. The search then is repeated for the next record in the packet.

If a matching entry is not found, then at step 212 a request is downloaded to the client computer 14. Referring to FIG. 12, at steps 116-122 a complete copy of the requested file is uploaded to the client server 12. Referring again to FIG. 16, at step 214 the complete copy along with the identifying information and the time stamp then are added to cache 200 as an entry. The time stamp for the added entry is the same time stamp as that from the earlier entries at step 210 of the same operation. As a result, there is an entry in the file cache 200 for every record in the original operation packet processed at steps 204-212. Some entries are made at step 210. The rest are made at step 214. Each entry for the operation has the same timestamp. It is the timestamp that is used to identify all records in a given operation stored in the file cache 200.

To perform an archival storage as part of the operation, the file contents are stored on an archival media with the identifying information. For some files the files are uploaded from the client computer (see step 214, and steps 116-122). For other files (see steps 204-212) the results of the search at step 206 are tested to identify an entry having the file contents. The file contents then are stored on the archival media.

To retrieve or restore that data from a back-up operation, the client computer 14 sends a request to the client server 12. The client server 12 searches the file cache 200 for entries with a matching client computer identifier. The matches correspond to the operations performed for the given client computer 14 which are sill in the file cache 200. To retrieve the data for a given operation, the time stamp is retrieved for a given match. The cache 200 then is searched to find all entries having the same timestamp. These entries are associated with the given operation. Every entry that is recovered includes one or more fields of file identifying information. Some entries may also include the file contents. For those entries which do not have the file contents, another search is performed in the file cache 200 to find other entries having the same identifying information. One of those found entries may have the file contents. As a result, the file contents are retrieved and downloaded to the client computer 14. In some instances the entry having the file contents may have been overwritten or purged from the file cache 200. In such case the file contents are not recovered from cache 200. A message is downloaded to the client computer to communicate that the file contents are unavailable. The user can then request that the archives be searched as described previously.

Additional Embodiments

In other embodiments the client server maintains the online storage system data structures separately for each client computer 14. For example, in the file cache 200 embodiment, there is a separate file cache 200 allocated for each one client computer 14. In an embodiment corresponding to the embodiment of FIGS. 5-9, there is a separate operation log, file log, central database and reference area for each client computer 14. In such embodiment there is no need to store a client computer identifier in each entry of the operation log and file log. A record is added to the central database when there are a threshold number of entries for the corresponding file in the file log. In a variation of this approach, the file log is omitted with the central database storing a record for each file, rather than just for those files which have been uploaded a threshold number of times.

Many modifications and variations of the present invention are possible in light of the above teachings. Thus, it is to be understood that, within the scope of the appended claims, the invention may be practiced otherwise than as described hereinabove

1. A method for uploading files for online storage in a global communication network having a client server computer and a plurality of client computers, the method comprising:
identifying files to be uploaded for online storage as part of a first operation;
for each identified file, generating a record to be uploaded to the client server computer, the record including identifying information for the corresponding file, the identifying information comprising file size and file checksum data;
receiving the records for the first operation at the client server computer;
creating a first operation storage area for the first operation in memory of the client server computer;
maintaining a central data base of records at the client server, wherein each record of the central database comprises file identifying information, wherein the file identifying information is not duplicated in any other record of the central database; and
for each one record received as part of the first operation, determining at the client server computer whether to request that the associated file be uploaded from the client computer, and adding an entry into the corresponding first operation storage area;
wherein said determining comprises testing the identifying information in said received one record to seek a match against identifying information of any records within the central database,
wherein for a case in which a match is found the associated file is not uploaded from the client computer and said adding comprises adding the identifying information as part of the corresponding entry in the first operation storage area, and wherein file contents for the associated file are not stored in the corresponding first operation storage area,
wherein for a case in which a match is not found, the associated file is uploaded from the client computer and said adding comprises receiving file contents for the associated file from the client computer and storing the received file contents and the unmatched identifying information as the entry in the first operation storage area.

2. The method of claim 1, further comprising the step of adding an entry into a file log for each one record received, wherein said entry comprises the identifying information for said one record, wherein a common file log is maintained at the client server for all client computers, and wherein for the case in which a match is not found, further comprising:
searching the file log to count a number of entries which have identical identifying information; and
when said number exceeds a threshold number creating a record in the central database for the identifying information.

3. The method of claim 1, wherein for the case in which a match is not found, further comprising the step of adding an entry into the central database when said identifying information has been uploaded to the client server computer for a threshold number of times.

4. The method of claim 1, wherein for the case in which a match is not found, further comprising the step of adding an entry into the central database when said identifying information has been uploaded to the client server computer by a threshold number of client computers.

5. The method of claim 1, in which the first operation is a back-up operation of files from the client computer to the client server computer, and further comprising:
identifying a back-up operation to restored to a requesting client computer;
locating the operation storage area for the identified back-up operation;
for each record in the located operation storage area, downloading the corresponding file contents to the client computer as part of a restore from back-up process.

6. The method of claim 5, further comprising prior to the step of downloading the steps of:
determining whether file contents associated with the identifying information of said record in the located operation storage area are present in said located operation storage area;
for the case in which the associated file contents are not present, searching the central database for the central database record with matching identifying information; and
accessing the file contents associated with the matching central database record as being the corresponding file contents to be downloaded for the corresponding record in the operation storage area.

7. The method of claim 1, further comprising the steps:
maintaining an operation log having an entry for each operation, each operation log entry comprising an operation identifier, and
recovering back-up files stored on the client server for a back-up operation, said recovering comprising the steps of:
downloading from the client server to a requesting client computer a list of back-up operations performed for the requesting client computer derived from a search of the operation log;
selecting at the client computer a back-up operation to restore from the list of back-up operations;
receiving at the client server an indication of the back-up operation to be restored;
locating the operation storage area corresponding to the indicated back-up operation; and
for each record in the located back-up storage area downloading the corresponding file contents to the client computer.

8. The method of claim 1, in which the first operation is a back-up operation and further comprising the steps of:
generating at the client server computer an archive copy of the identified files onto a portable media.

9. The method of claim 8, in which the step of generating comprises:
for an identified file, searching the central database for a central database record identifying information which matches the identifying information of the identified file; and
accessing the file contents associated with the matched central database record as being the corresponding file contents to be included in the archive copy.

10. The method of claim 1, in which the first operation is a publishing operation and further comprising the steps of:
receiving an indication from the client computer requesting the publishing operation a number of copies to publish; and
generating at the client server computer a copy of the identified files onto a portable media for each of said number of copies to publish.

11. The method of claim 10, in which the step of generating comprises:
for an identified file, searching the central database for a central database record identifying information which matches the identifying information of the identified file; and
accessing the file contents associated with the matched central database record as being the corresponding file contents to be included in each of said number of copies.

12. The method of claim 1, further comprising the steps of:
generating a first icon at the client computer for accessing online storage;
in response to activation of the icon, displaying a directory of online storage data generated during prior upload operations by the client computer.

13. The method of claim 12, wherein the directory comprises a listing of back-ups.

14. The method of claim 13, wherein the directory comprises a listing of files associated with a select back-up among said listing of back-ups.

15. The method of claim 1, in which the first operation is a publishing operation and further comprising the steps of:
generating a first icon at the client computer for accessing a publication from online storage, wherein the publication is an image file having an image file type from among a group of image file types including a video image, an audio image, an audio-video image and a multimedia image; and
in response to activation of the first icon, streaming the image file from the client server to the requesting client computer for real-time playback at the requesting client computer.

16. A method for uploading files for online storage in a global communication network having a client server computer and a plurality of client computers, the method comprising:
identifying files to be uploaded as part of a first operation;
for each identified file, generating a record to be uploaded to the client server computer, the record including identifying information for the corresponding file, the identifying information comprising file size and file checksum data;
receiving the records for the first operation at the client server computer;
for each one record received as part of the first operation, testing data records of a database to determine whether there is a record in the database having the same identifying information, for the case in which there is a record in the database with matching identifying information, adding a new record into the database which includes an operation identifier and the identifying information without corresponding file contents;
wherein for the case in which there is not a record in the database with matching identifying information, receiving the file contents from the client computer, and adding a new record into the database which includes an operation identifier, the identifying information, and the corresponding file contents.

17. The method of claim 16, in which the operation identifier comprises a timestamp.

18. The method of claim 16, in which the database is a file cache.

19. The method of claim 16, in which the first operation is a back-up operation, and further comprising:
identifying the back-up operation which corresponds to a requested restore-from-back-up from a requesting client computer;
locating each record in the database corresponding to the identified back-up operation; and
for each located record in the database having file contents downloading the file contents to the client computer; and
for each located record in the database having not file contents, locating another record in the database which has file contents and the same identifying information, and downloading the file contents of said another record to the client computer.

20. The method of claim 16, in which the first operation is a back-up operation and further comprising the steps of:
generating at the client server computer an archive copy of the identified files onto a portable media.

21. The method of claim 20, in which the step of generating an archive copy comprises:
for an identified file, searching the database for an entry having identifying information which matches the identifying information of the identified file and which includes file contents; and
storing the file contents from the matched information in the archive copy as being the corresponding file contents for the identified file.

22. The method of claim 16, in which the first operation is a publishing operation and further comprising the steps of:
receiving an indication from the client computer requesting the publishing operation a number of copies to publish;
generating at the client server computer a copy of the identified files onto a portable media for each of said number of copies to publish.

23. The method of claim 22, in which the step of generating the copy onto portable media comprises:
for an identified file, searching cache memory for an entry having identifying information which matches the identifying information of the identified file and which includes file contents; and
storing the file contents from the matched information as being the corresponding file contents for the identified file to be included in each of said number of copies.

24. The method of claim 16, further comprising the steps of:
generating a first icon at the client computer for accessing online storage;
in response to activation of the icon, displaying a directory of online storage data generated during prior upload operations by the client computer.

25. The method of claim 24, wherein the directory comprises a listing of back-ups.

26. The method of claim 25, wherein the directory comprises a listing of files associated with a select back-up among said listing of back-ups.

27. The method of claim 16, in which the first operation is a publishing operation and further comprising the steps of:
generating a first icon at the client computer for accessing a publication from online storage, wherein the publication is an image file having an image file type from among a group of image file types including a video image, an audio image, an audio-video image and a multimedia image; and
in response to activation of the first icon, streaming the image file from the client server to the requesting client computer for real-time playback at the requesting client computer.

28. An online storage system, comprising:
a client server computer comprising system memory and expandable memory,
a plurality of client computers;
means for carrying communications between the plurality of client computers and the client server computer;
means for identifying files to be uploaded for online storage as part of a first operation;
means for generating, for each identified file, a record to be uploaded to the client server computer, the record including identifying information for the corresponding file, the identifying information comprising file size and file checksum data;
a reference storage area within client server computer system memory comprising a first operation storage area for the first operation;
a central data base within client server memory system memory comprising records, wherein each record comprises file identifying information, wherein the file identifying information is not duplicated in any other record of the central database; and
means for determining at the client server computer, for each one record received as part of the first operation, whether to request that the associated file be uploaded from the client computer
means for adding, for each one record received as part of the first operation, an entry into the corresponding first operation storage area;
wherein said determining means comprises means for testing the identifying information in said received one record to seek a match against identifying information of any records within the central database,
wherein for a case in which a match is found the associated file is not uploaded from the client computer and said adding means comprises means for adding the identifying information as part of the corresponding entry in the first operation storage area, and wherein file contents for the associated file are not stored in the corresponding first operation storage area,
wherein for a case in which a match is not found, the associated file is uploaded from the client computer and said adding means comprises means for receiving file contents for the associated file from the client computer and means for storing the received file contents and the unmatched identifying information as the entry in the first operation storage area.

29. The system of claim 28, further comprising a file log;
means for adding an entry into the file log for each one record received from a client computer, wherein said entry comprises the identifying information for said one record, wherein a common file log is maintained at the client server for all client computers; and
means for searching the file log, for the case in which a match is not found, to count a number of entries which have identical identifying information; and
when said number exceeds a threshold number means for creating a record in the central database for the identifying information when said number exceeds a threshold number.

30. The system of claim 28, further comprising:
an operation log at the client server computer having an entry for each operation, each operation log entry comprising an operation identifier, and
means for recovering back-up files stored on the client server for a back-up operation listed in the operation log.

31. The system of claim 28, in which the first operation is a back-up operation and further comprising:
means for generating at the client server computer an archive copy of the identified files onto a portable media.

32. The system of claim 31, in which the generating means comprises:
means for searching the central database for a central database record with identifying information which matches the identifying information of an identified file being backed-up; and
means for accessing the file contents associated with the matched central database record as being the corresponding file contents to be included in the archive copy.

33. The system of claim 28, in which the first operation is a publishing operation and further comprising:
means for receiving an indication from the client computer requesting the publishing operation a number of copies to publish; and
means for generating at the client server computer a copy of the identified files onto a portable media for each of said number of copies to publish.

34. The system of claim 28, further comprising:
means for generating a first icon at the client computer for accessing online storage;
means for displaying, in response to activation of the icon, a directory of online storage data generated during prior upload operations by the client computer.

35. The system of claim 34, wherein the directory comprises a listing of back-ups.

36. The system of claim 35, wherein the directory comprises a listing of files associated with a select back-up among said listing of back-ups.

37. The system of claim 28, in which the first operation is a publishing operation and further comprising:
means for generating a first icon at the client computer for accessing a publication from online storage, wherein the publication is an image file having an image file type from among a group of image file types including a video image, an audio image, an audio-video image and a multimedia image; and
means for streaming, in response to activation of the first icon, the image file from the client server to the requesting client computer for real-time playback at the requesting client computer.

38. The system of claim 28, in which the reference storage means comprises:
a plurality of storage space portions, wherein each one storage space portion of the plurality of storage space portions is dedicated to a corresponding one client computer among the plurality of client computers; and
in which the central database comprises a plurality of database portions, wherein each one database portion of the plurality of database portions is dedicated to a corresponding one client computer among the plurality of client computers.
